(19) United States
(12) Patent Application Publication
(10) Pub. No.: US 2017/0098947 A1
(43) Pub. Date: Apr. 6, 2017

(54) BATTERY HANDLING APPARATUS

(71) Applicant: Hand Held Products, Inc., Fort Mill, SC (US)

(72) Inventor: Matthew Wolski, Charlotte, NC (US)

(21) Appl. No.: 14/873,818

(22) Filed: Oct. 2, 2015

(51) Int. Cl. H02J 7/00; H02J 7/04; H02J 7/02

(52) U.S. Cl. CPC H02J 7/0045; H02J 7/0052; H02J 7/007; H02J 7/025; H02J 7/042

(57) ABSTRACT

A battery handling apparatus is structured to compatibly associate with a handheld device to remove a battery therefrom or insert a battery thereinto. The apparatus comprises a device receiver of the apparatus, structured to receive a handheld device having a removable battery, a battery release assembly operative to engage the battery retention means and manipulate it so as to unsecure the battery from the device, and a battery retention mechanism structured to engage the released battery to permit its retention within the apparatus.

### FIELD OF THE INVENTION

The present invention relates to an apparatus for the removal of a battery from a battery-powered device. More particularly, the present invention relates to an apparatus suitable for hands-free removal of a battery from such devices.

### BACKGROUND

Battery-powered and/or handheld devices are prevalent in many environments. Such devices may employ corded or cordless power, and their functionalities may place substantial demands on battery life.

In a healthcare setting, handheld devices are used to perform a variety of functions, such as scanning an identifier on a patient wristband, medication container, intravenous infusion fluid bag, medicament dispenser, or other relevant item.

In this example, a nurse or other healthcare worker typically uses a handheld device to scan information associated with various objects. The information may be text or encoded in a barcode, quick response (2D) code, or other format.

The captured data may assist in identification of a patient or medication, be used in facility inventory control, document electronic recordkeeping of the healthcare delivery, and/or represent a safety measure to prevent mistakes (e.g. administration of an incorrect medication, missed or duplicate drug dosing).

Cordless devices in the healthcare environment present unique use requirements. Healthcare services in a hospital are provided around the clock, necessitating frequent replacement of handheld device batteries. It is estimated that the average handheld scanning device experiences roughly 2,000 battery exchanges during its product life.

Conventional handheld/mobility devices require a user to manually remove the battery, which commonly is secured within the device by a clip, latch, spring, or other retention means. Therefore, a battery exchange requires the user to free the battery of the retention mechanism, remove it and place it on a battery charger, obtain a charged battery and reinsert it into the device, and ensure that the new battery is securely retained.

This presents two significant problems for users in an acute hospital setting. First, nurses generally are required to keep fingernails trimmed to no longer than the end of the fingertips. Battery removal processes requiring longer nails to pry open a battery door, retract a spring, or the like are difficult to perform with properly-groomed nails. Additionally, the nurse with properly shortened fingernails may incur pain or even injury in attempting to remove the battery.

Second, a strong focus continues to exist to reduce healthcare-associated infections (HAIs). Because of its mobility, the handheld device potentially may serve as a vector for microbial contamination. Battery handling results in increased contact incidents, which in turn increase the risk of germ transport within the environment. A reduction in the number of device touches is greatly preferred to help prevent HAIs.

Therefore, a need exists for an apparatus capable of removing a battery from a handheld device with minimal participation by a user.

### SUMMARY

Accordingly, in one aspect, the present invention embraces an apparatus capable of removing a battery from a handheld device. This removal preferably is “fingernail-free” from the user's perspective.

The inventive apparatus and handheld devices possess a compatible structural relationship, such that the device body is favorably received by the battery removal apparatus to permit the latter to engage and defeat a battery retention means within the device.

In a first exemplary embodiment, the inventive apparatus comprises an apparatus housing including a first device receiver. The device receiver is structured to receive a handheld device having a removable battery. A battery release assembly is operative to engage the battery retention means and manipulate it so as to unsecure the battery from the device. A battery retention mechanism engages the released battery to permit its retention within the apparatus.

In another exemplary embodiment, the inventive apparatus is structured to facilitate insertion of a removable battery into a handheld device. In this embodiment, a device receiver presents a removable battery. A handheld device is placed in the receiver, and the battery is introduced into the battery compartment of the device. The battery retention mechanism of the device operates to retain the battery therein.

In another aspect, the present invention embraces battery removal and insertion functionalities. In one embodiment of this aspect, the battery removal apparatus comprises a plurality of device bays. A first device bay is structured to remove a battery from the device, and a second device bay is structured to insert a battery into the device.

In an alternative embodiment of this aspect, a device bay of the apparatus is structured to perform both removal and insertion processes.

In yet another exemplary embodiment, the battery removal apparatus comprises a battery handling system, which permits a removed battery to be associated with a battery charging system. The apparatus can have a charging system incorporated therein, or a non-integral charging system may be employed. The non-integral charging system need only rechargeably communicate with a battery residing in association with the battery removal apparatus.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1A is a perspective view of a prior art handheld device.

FIG. 1B graphically depicts a portion of the handheld device of FIG. 1A, showing components thereof.

FIG. 2 is a perspective view of a first embodiment of the battery handling apparatus according to the present disclosure.

FIG. 3A graphically depicts a device receiver of the apparatus of FIG. 2, showing orientation of elements with respect to a conventional handheld device.

FIG. 3B graphically depicts the device receiver of FIG. 3A engaging a handheld device.

FIG. 4 graphically depicts a battery staging aspect of the battery handling apparatus according to the present disclosure.

### DETAILED DESCRIPTION

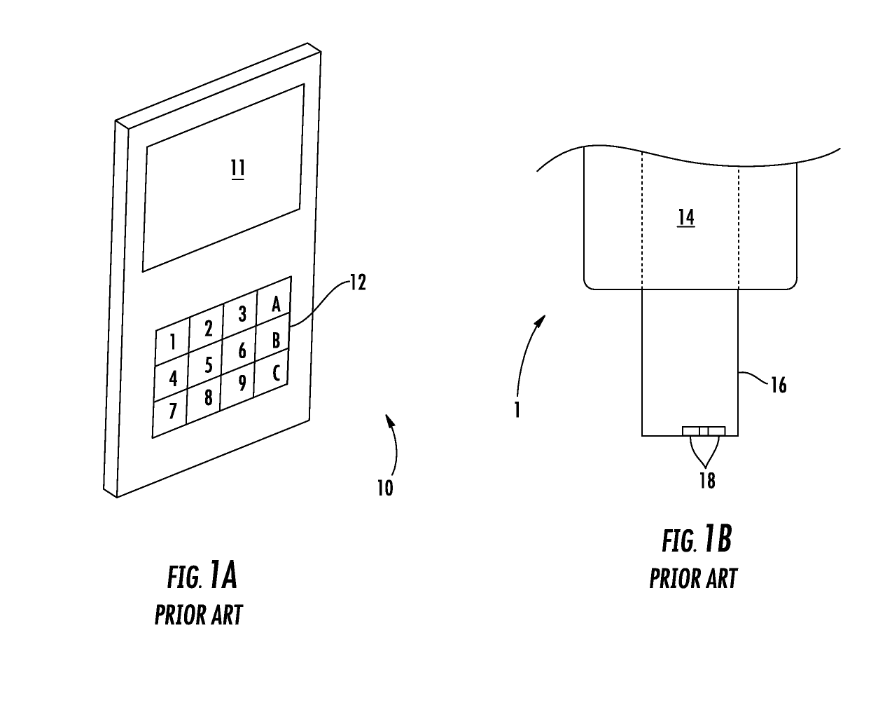

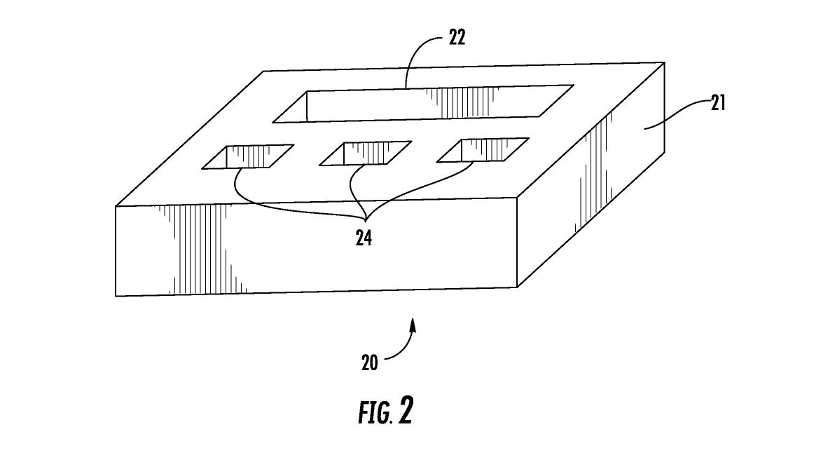

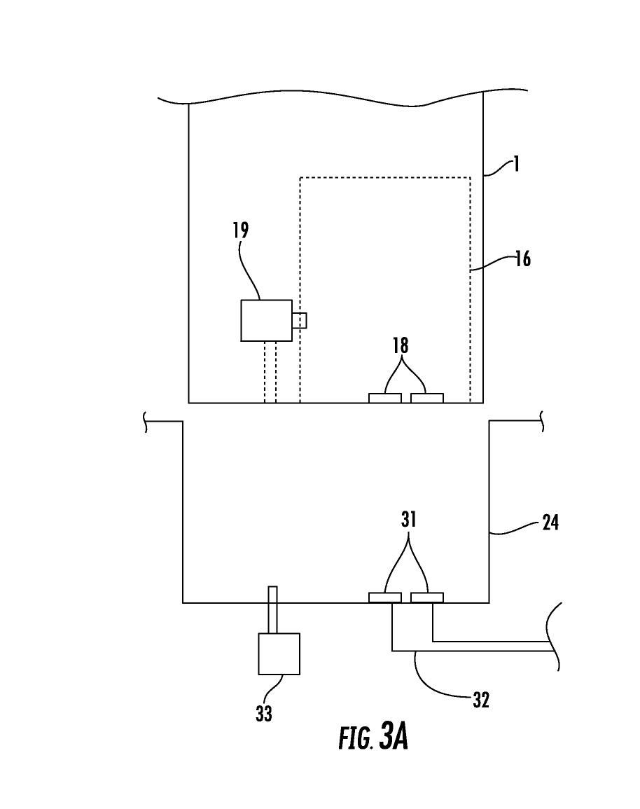

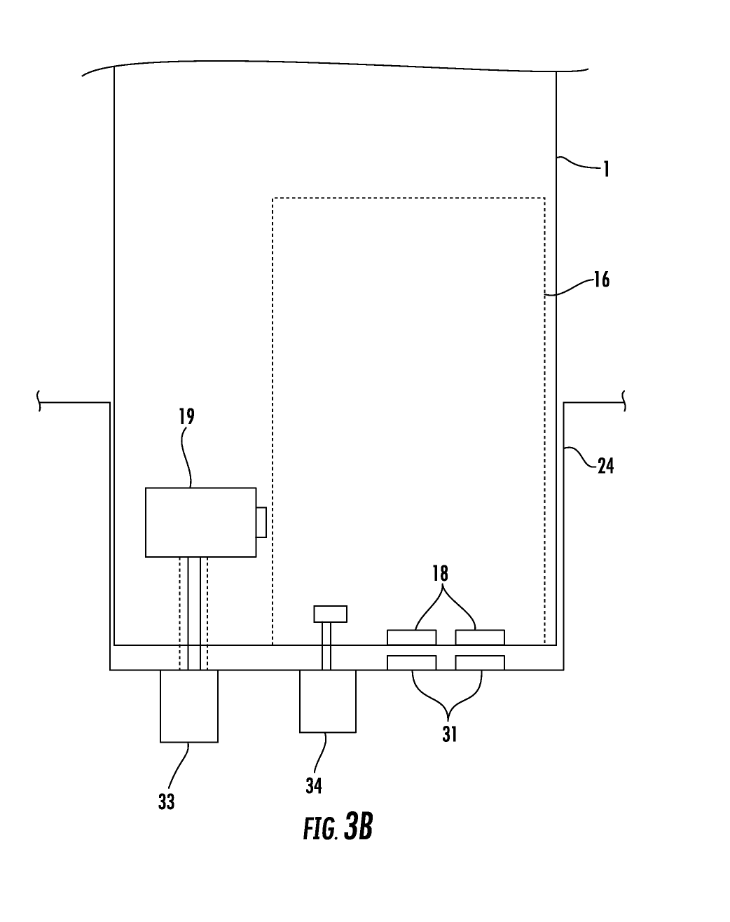

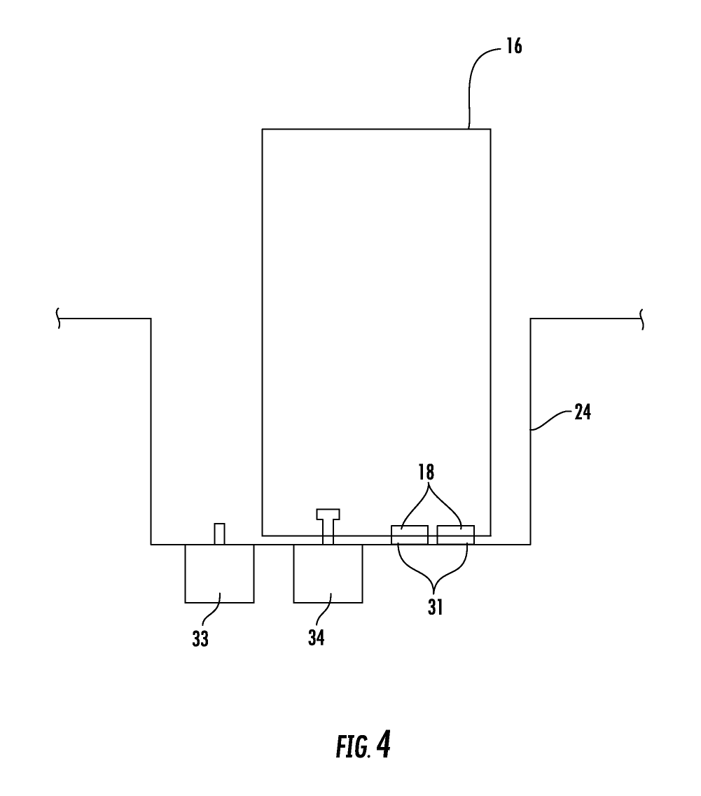

The present battery handling apparatus is structured to handle a removable battery associated with a handheld device. Such a handheld device 1 (FIG. 1A) generally has a removable battery 16 secured in the device by a battery retention mechanism 19 (FIG. 3A). The device 10 further may include a display 11 and/or a keypad or other data entry interface 12.

Generally, a first embodiment of the inventive apparatus comprises an apparatus housing 21 shaped to define an internal volume and suitable to house internal components of the apparatus. The housing can be designed to permit various placement options of the apparatus, e.g. a countertop or other work surface, a cart, a wall mounting.

Suitable materials for the housing's manufacture include metal, polymer, composites, and combinations or mixtures thereof. If the apparatus is intended for use in a healthcare setting, the housing preferably is constructed of specialty materials resistant to degradation by cleaning solutions commonly used in such environments. If desired, the material (or a portion thereof) alternatively or additionally may be infused or treated with one or more biocidal agents to impart a sanitary property thereto.

The housing comprises a device receiver 24 structured to compatibly receive a handheld device 10 having a removable battery 16. The device receiver can be a recess or depression in the apparatus housing (i.e., a bay or well). Alternatively, the receiver can be at least partially outside the internal volume of the housing.

A first aspect of the battery handling apparatus is a battery removal module structured to remove a battery 16 from a handheld device 10. In a first embodiment of this aspect (FIG. 3A), the battery removal module comprises a battery release assembly 33 and a battery engager 34.

The battery release assembly 33 is structured to engage and defeat the battery retention means 19 of the handheld device 10, so as to unsecure the battery 16 therefrom. The specific structure of the battery release mechanism employed in the apparatus may vary and will be dictated by compatibility with the corresponding battery retention mechanism of the device.

In one embodiment, the battery release assembly 33 can be a physical element operative to disengage a corresponding retention clip or spring in the handheld device.

Exemplary elements include, without limitation, a pin, prong, bladed element, flange, wheel, or other suitable structure.

In another embodiment (FIGS. 3A, 3B), the battery release mechanism can be oriented as a movable element. Movement can be extension, retraction, slide, rotation, or combinations thereof. Movement of the battery release mechanism can be facilitated by a hinge, pivot, lever, or other structural arrangements as are known in the art.

It is preferred, although not required, that the battery release assembly 33 operate passively in response to the association of a handheld device 10 with the battery receiver. However, alternative embodiments of the battery release mechanism can utilize active engagement of the device's battery retention mechanism 19 by the battery release assembly 33, e.g. by a solenoid.

The battery engagement assembly is structured to affirmatively engage the battery 16. Engagement can be physical, magnetic, or other means known in the art. The engagement assembly can be further operative to retain the released battery in the present apparatus, should the handheld device be removed from the device receiver.

Some handheld devices may retain the removable battery essentially wholly within the device case, such that the battery cannot be tangibly accessed unless it is at least partially withdrawn. To accommodate this possibility, the battery handling mechanism of the present invention can be positioned so as to provide a space or volume for at least partial withdrawal of the released battery.

A second aspect of the present apparatus is a battery insertion module structured and operative to introduce a battery 16 into the battery compartment 14 of a handheld device 10.

In a first embodiment according to this aspect (FIG. 4), the apparatus includes a battery insertion module associated with the device receiver 24. The battery insertion module comprises a battery stager.

As above, the device receiver 24 is structured to compatibly receive the handheld device 10. The battery stager is arranged to present a removable battery 16 for insertion into the battery compartment 14 of the device 10. The stager can be structured similarly to the battery engagement mechanism described above.

Insertion of the staged removable battery 16 into the device's battery compartment 14 is expected to trigger engagement of the battery by the device's battery retention mechanism 19. The battery, once so engaged and thus retained within the device, is released by the battery stager.

The above first and second aspects can be combined in the battery handling apparatus. In one combined embodiment, the battery removal apparatus comprises a plurality of device receivers. A first device receiver comprises a battery removal module, and a second device receiver comprises a battery insertion module.

In an alternative combined embodiment, a device receiver of the apparatus comprises both battery removal and battery insertion modules.

A third aspect of the inventive apparatus embraces a battery charging module operative to electrically charge a battery 16 engaged by the apparatus. The battery charging module can be incorporated within the apparatus, or a non-integral charging system may be employed. The non-integral charging system need only chargeably communicate with a battery residing in association with the battery removal apparatus.

In an exemplary embodiment, the battery charging module comprises charging leads 31/32, positioned to contact corresponding charging contacts 18 of the removable battery 16. In another embodiment, charging can be accomplished by conductive or inductive charging technologies.

A fourth aspect of the battery handling apparatus is a microprocessor configured to monitor and/or control various functions of the apparatus.

In a first embodiment according to this aspect, the microprocessor can be configured to log battery removals and insertions. Logging comprises obtaining device identification data and time. Other parameters may optionally be obtained, such as user identification data, battery identification data, battery charge level, battery charging status (if a battery charging module is employed), and the like.

Device identification data can be obtained from conventional handheld devices having unique identification data assigned thereto. The microprocessor can be configured to acquire this identification data when the device is associated with the apparatus. Acquisition can be via direct contact with electrical leads of the device, near-field communication, wireless communication (e.g. IEEE 802.15.1/Bluetooth® and the like), and other suitable technologies.

User identification data can be obtained by affirmative entry by a user, which can be optional or mandatory to the removal/insertion procedure. Alternatively, a radio-frequency identification (RFID) signal of the user can be detected, such as from an identification badge or security key card or fob uniquely assigned to the user.

Information obtained by the microprocessor can be exploited to achieve a broad variety of risk management objectives, including without limitation: (a) logging battery change history to provide a record of compliance with device readiness policy; (b) documenting users' battery-change activities, to identify “low-risk” users, identify and rehabilitate “high-risk” users, and record user activity irregularities; (c) monitoring battery life and charge history, enabling preemptive identification of a battery developing “memory effect” or other unwanted performance behavior; control (i.e., activation, deactivation) of apparatus components, for example to prevent a low-charge battery from being loaded into a handheld device.

The microprocessor can be configured to communicate with a display associated with the housing. The display can be operative to show various information, such as battery charge status. The information can be displayed in textual form, e.g. “22%”, “Do Not Use”. Alternatively or additional, a graphic display can be employed. The graphic display can be black-and-white, greyscale, or color. Specific graphics include, without limitation, lights, progress bars, wheels, symbols (such as the internationally standardized “NO” circle-and-diagonal slash symbol, ISO 3864), and the like.

The microprocessor further can be programmed to compare obtained information against reference data. Obtained information falling outside a reference range can generate an alert signal, allowing for investigation of the abnormality.

Operation.

The battery handling operation favorably may be likened to the procedure for removal or ejection of an ammunition magazine from a modern pistol, in which the magazine is retained within the grip portion of the pistol frame. A user activates a magazine release “catch” (most commonly a button or lever) to disengage the firearm's magazine retention mechanism. The released magazine typically falls or is positively ejected from the grip portion without the need to physically withdraw it.

Conceptually, the handheld device can be likened to the pistol, the battery to the magazine, and the device's battery retention mechanism to the pistol's magazine retention mechanism.

Proper contact of the handheld device with the device receiver preferably actuates the battery release assembly, much as actuation of a handgun's magazine release catch defeats the magazine retention mechanism. The battery release mechanism in turn defeats the device's battery retention mechanism, thus enabling removal of the battery.

In practice, a user associates with a device receiver a handheld device having a removable battery in a battery compartment. The battery removal module is activated, passively or actively, to engage and defeat the device's battery retention mechanism. The removable battery thereby is unsecured from the device and can be removed therefrom.

The device battery may be positively ejected from the device, be able to exit the battery compartment of the device under the influence of gravity, or remain within the battery compartment. These various fates each can be accommodated by the inventive apparatus through positioning of the components of the battery removal module.

The battery engagement assembly positively engages the removed battery to retain it in association with the apparatus and permit removal of the handheld device without concomitant removal of the just-released battery.

Engagement of the battery facilitates at least partial removal of the battery from the handheld device. Where removal is partial, complete removal can be effected upon disassociation of the handheld device from the device receiver of the apparatus.

A procedure for inserting a removable battery into the battery compartment of the device comprises staging a battery in the device receiver, and introducing a handheld device into association with the device receiver. In a simple orientation, the battery stands upright in the receiver, and introduction of the device comprises associating it in the receiver such that the battery is slidably inserted into the device's battery compartment.

The device's battery retention means preferably is triggered or manipulated to secure the inserted battery within the device. The battery retention engager of the present apparatus can be disabled (mechanically or by the microprocessor) to permit engagement of the device's battery retention means.

The present battery handling apparatus possesses several advantages over conventional devices and procedures. In the healthcare setting, the device and battery both move throughout the facility and in close quarters with patients and contaminated articles (e.g. medical equipment, sheets, bedpans). Removal of the battery without contact by the user therefore is greatly preferred to reduce the risk of microbial contamination, as the user's hands need not unduly contact the device or battery surfaces.

Further, a hands-free procedure eliminates the discomfort associated with manual battery removal. Battery removal and exchange therefore is encouraged, minimizing the risk of device failure due to a dead battery and improving patient care and risk management.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER′S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A battery handling apparatus, comprising:
an apparatus housing defining an internal volume;
a device receiver structured to receive a handheld device having a removable battery; and
a battery removal module comprising:
a battery release assembly structured to disable a battery retention mechanism of the handheld device, and
a battery engager structured to engage the removable battery and secure it in association with the apparatus.

2. The apparatus according to claim 1 wherein the battery release assembly comprises a pin, a prong, or a flange.

3. The apparatus according to claim 2 wherein the battery release assembly further comprises a contact, positioned to electrically contact at least one of a contact of the handheld device or a contact of the removable battery and operative to, once electrically contacted, activate a mechanical battery release element.

4. The apparatus according to claim 1 wherein the battery engager is a clip, a prong, a pincer, a blade, or a spring.

5. The apparatus according to claim 1 wherein the battery engager is a magnet.

6. The apparatus according to claim 1, further comprising a battery insertion module associated with a device receiver, the battery insertion module including a battery stager structured to present a removable battery for insertion into the battery compartment of the device.

7. The apparatus according to claim 6 wherein the battery release mechanism is disabled.

8. The apparatus according to claim 1, further comprising a charging module operative to electrically charge a battery engaged by the apparatus.

9. The apparatus according to claim 8 wherein the charging module comprises:
one or more charging leads arranged to contact a corresponding one or more battery contacts of the removable battery; and
a direct electrical charging mechanism structured to deliver an electrical power to the removable battery through the charging leads and the battery contacts.

10. The apparatus according to claim 8 wherein the charging module comprises a conductive charging mechanism or an inductive charging mechanism.

11. The apparatus according to claim 1, further comprising a microprocessor configured to monitor and/or control various functions of the apparatus.

12. The apparatus according to claim 11 wherein an apparatus function is obtaining data from the handheld device.

13. The apparatus according to claim 11 wherein an apparatus function is obtaining data from the removable battery.

14. The apparatus according to claim 11 wherein an apparatus function is obtaining data from a handheld device user.

15. The apparatus according to claim 11 wherein an apparatus function is logging a battery handling apparatus activity.

16. The apparatus according to claim 15 wherein logging a battery handling apparatus activity comprises obtaining at least one of handheld device identification, battery identification, user identification, time, or battery charge level.

17. The apparatus according to claim 16 wherein an apparatus function is logging an apparatus activity.

18. The apparatus according to claim 16 wherein an apparatus function is comparing a removable battery profile to a reference profile.

19. The apparatus according to claim 18 wherein the comparing function further comprises generating an alert signal if a value of a compared removable battery profile differs from a corresponding value of the reference profile by a predetermined amount.

20. A battery handling apparatus, comprising:
an apparatus housing defining an internal volume;
a device receiver structured to receive a handheld device having a removable battery; and
a battery removal module associated with a device receiver, the battery removal module including:
a battery release assembly structured to disable a battery retention mechanism of the handheld device, and
a battery engager structured to engage the removable battery and secure it in association with the apparatus;
a charging module operative to electrically charge a battery engaged by the apparatus, the charging module including:
one or more charging leads arranged to contact a corresponding one or more battery contacts of the removable battery, and
an electrical charging mechanism structured to deliver an electrical power to the removable battery through the charging leads and the battery contacts; and
a microprocessor configured to monitor and/or control a function of the apparatus.
